(19) United States
(12) Patent Application Publication
(10) Pub. No.: US 2021/0392853 A1
(43) Pub. Date: Dec. 23, 2021

(54) ANIMAL FEEDER APPARATUS

(71) Applicant: Lamar Everette Parker, York, SC (US)

(72) Inventor: Lamar Everette Parker, York, SC (US)

(21) Appl. No.: 17/350,802

(22) Filed: Jun. 17, 2021

Related U.S. Application Data
(60) Provisional application No. 63/040,227, filed on Jun. 17, 2020.

(51) Int. Cl. A01K 5/02; F16M 11/22

(52) U.S. Cl. CPC A01K 5/0225; F16M 11/22

(57) ABSTRACT

An animal feeder apparatus includes a container for storing animal feed and a dispenser operatively connected to the container and configured to dispense the animal feed from the container. The apparatus further includes a plurality of support members to support the container and dispenser at an elevation above the ground. Each of the support members has a respective first segment and a respective second segment. Each of the first segments is substantially horizontal. Each of the second segments is generally vertical. The support members are connected to the container at or near the first segments.

### CROSS-REFERENCE TO RELATED APPLICATION

This application claims the benefit of U.S. Provisional Patent Application No. 63/040,227, filed Jun. 17, 2020, and which is hereby incorporated by reference in its entirety.

### TECHNICAL FIELD

This disclosure relates to devices for storing and dispensing grain for consumption by animals.

### BACKGROUND

Animal feeders are sometimes used to provide nourishment to various animals, such as deer, elk, etc., and to draw them to a predetermined location for observation, harvesting, etc. Some animal feeders include a container configured to store animal food, such as grain, pellets, etc., and a dispenser that releases the animal food from the container. Typically, the container and the dispenser are supported above the ground by a plurality of support members in a tripod arrangement.

The container of food often attracts unwanted animals, such as squirrels, raccoons, etc., that climb the support members to access food in the container, thereby consuming food that was intended for other types of animals.

### SUMMARY

An animal feeder apparatus includes a container for storing animal feed and a dispenser operatively connected to the container and configured to dispense the animal feed from the container. The apparatus further includes a plurality of support members to support the container and dispenser at an elevation above the ground. Each of the support members has a respective first segment and a respective second segment. Each of the first segments is substantially horizontal. Each of the second segments is generally vertical. The support members are connected to the container at or near the first segments. In one embodiment, the support members are connected to the container at or near the top of the container.

The animal feeder apparatus provided herein improves upon the prior art by preventing access to the container and the feed container therein from unwanted animals. The horizontal segment of the support members, and its placement at or near the top of the container, prevents such animals from accessing the container or the dispenser by climbing the support members. More specifically, the arrangement and placement of the support members results in a horizontal distance between the support members and the dispenser that is not possible for various animals to traverse.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is schematic, perspective view of an animal feeder apparatus with support members in accordance with the claimed invention;

FIG. 2 is a schematic, side view of a portion of one of the support members of FIG. 1; and

FIG. 3 is a schematic, side view of a portion of an alternative animal feeder apparatus in accordance with the claimed invention.

### DESCRIPTION OF THE PREFERRED EMBODIMENTS

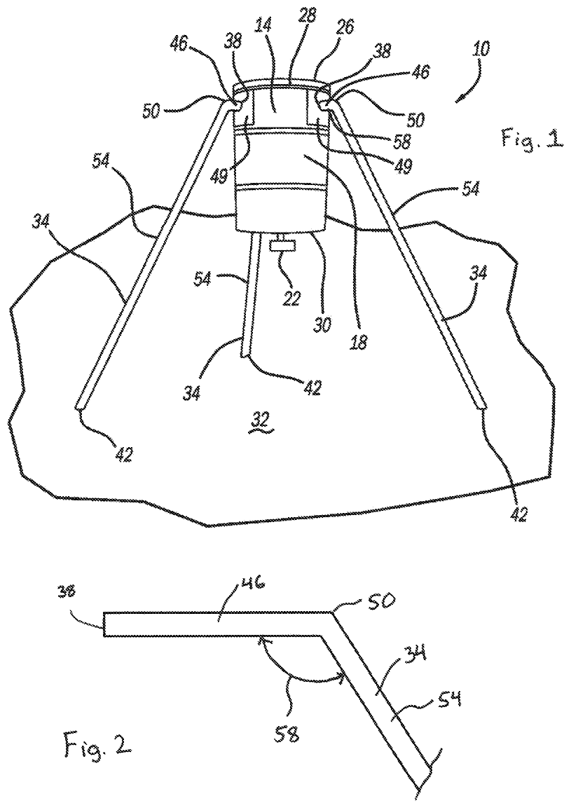

Referring to FIGS. 1 and 2, wherein like reference numbers refer to like components, an animal feeder apparatus 10 is schematically depicted. The animal feeder apparatus 10 includes an animal feeding system 14. The animal feeding system 14 includes a container 18 and a dispenser 22. The container 18 defines a storage compartment that, during use, contains animal feed, which is typically in granular form, such as corn or pellets.

In the embodiment depicted, the container 18 is a substantially cylindrical, drum-style container with a lid 26. The lid 26 covers the upper opening to the storage compartment formed at the upper end 28 of the container 18. The lid 26 is removable to add animal feed to the compartment. It should be noted that other shapes and sizes of container 18 may be employed within the scope of the claimed invention. Those skilled in the art will recognize a variety of suitable materials that may be employed to form the container 18 within the scope of the claimed invention, including, but not limited to, various metals and polymers.

The container 18 defines an opening at its bottom end 30 through which feed in the storage compartment is gravity-fed to the dispenser 22. The dispenser 22 is connected to the container 18 and is positioned under the container 18 to receive the feed from the storage compartment. In one embodiment, the dispenser 22 includes an electric motor for spinning a distributor, which broadcasts the feed to the area surrounding the animal feeding system 14, as understood by those skilled in the art. A timer or other control device may periodically energize the motor so that the apparatus 10 distributes or dispenses feed at predetermined times or intervals.

The animal feeding system 14 is supported at a height above the ground 32 by a plurality of support members 34. In the embodiment depicted, the apparatus 10 includes three support members 34, though any number of support members 34 sufficient to support the animal feeding system 14 may be employed within the scope of the claimed invention. The support members 34 are substantially identical to one another in the embodiment shown. Each support member 34 includes a respective first end 38 and a respective second end 42. Each support member 34 includes a linear first segment 46 that extends from the first end 38 to the intersection 50 with a linear second segment 54. The second segment 54 extends from the intersection 50 to the second end 42.

The first end 38 of each support member 34 is attached to the container 18, such as via a plate 49. Each plate 49 may be integrally formed with the first end 38, or attached to the end 38, such as by welding. The plates 49 are curved in the embodiment depicted to maintain surface-to-surface contact with the cylindrical exterior surface of the container 18. The first segments 46 extend radially outward relative to the centerline of the container 18 such that the first segments 46 are substantially perpendicular to the surface of the container at the location at which they are mounted thereto.

On each support member 34, the second segment 54 forms an obtuse angle 58 with the first segment 46. The angle 58 in the embodiment depicted is between 90 degrees and 135 degrees. Accordingly, when the apparatus 10 is in the position shown in FIG. 1, with all of the ends 42 on the ground 32, the second segments 54 are generally vertical, i.e., more vertical than horizontal, and the first segments 48 are substantially horizontal.

The vertical distance between the bottom end 30 and the top end 28 defines the height of the container 18. The first segments 46 are connected to the container 18 in the upper half of the height, and, more preferably, in the upper 25% of the height. In one embodiment, the first segments 46 are connected to the container in the upper 10% of the height.

The length of the second segments 54 is determined by the desired height of the feeding system 14 from the ground 32. In one embodiment, the length of the first segments 46 is at least 5 inches, and may, for example, be at least 24 inches. Those skilled in the art will recognize a variety of materials that may be used to form the support members 34 within the scope of the claimed invention, including, but not limited to, various metals. It should be noted that each support member 34 may be characterized by one-piece construction, in which the segments 46, 54 and/or the plates 49 are all formed from a single piece of material, within the scope of the claimed invention.

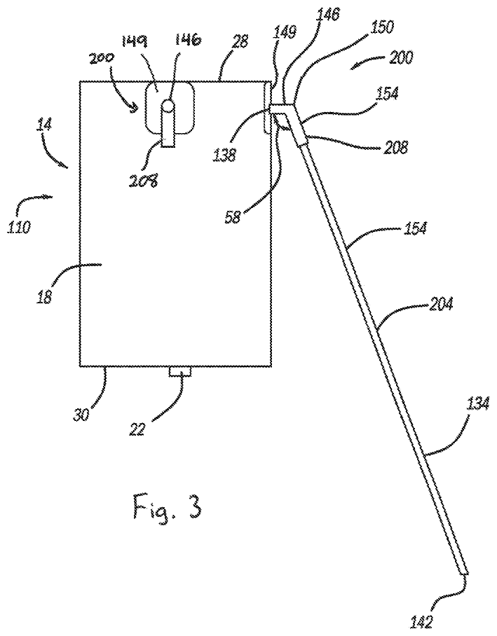

Likewise, it should also be noted that the support members 34 may be formed from a plurality of pieces that are operatively interconnected within the scope of the claimed invention. FIG. 3 shows a portion of an animal feeder apparatus 110 according to an alternative embodiment in which the support members 134 are multi-piece. Referring to FIG. 2, wherein like reference numbers refer to like components from FIG. 1, animal feeder apparatus 110 includes an animal feeding system 14 with a container 18 and a dispenser 22. The animal feeder apparatus 110 is substantially identical to the animal feeder apparatus shown at 10 in FIG. 1, except that each of the support members 134 of apparatus 110 is formed by a respective bracket 200 and pole 204.

Support members 134 are substantially identical to the support members shown at 34 in FIG. 1 in size and shape. More specifically, each support member 134 (only one of which is completely shown in FIG. 2) includes a respective first end 138 and a respective second end 142. Each support member 134 includes a linear first segment 146 that extends from the first end 138 to the intersection 150 with a linear second segment 154. The second segment 154 extends from the intersection 150 to the second end 142.

The first end 138 of each support member 134 is attached to the container 18, such as via a plate 149. Each plate 149 may be integrally formed with the first end 138, or attached to the end 138, such as by welding. The plates 149 are curved in the embodiment depicted to maintain surface-to-surface contact with the cylindrical exterior surface of the container 18. The first segments 146 extend radially outward relative to the centerline of the container 18 such that the first segments 146 are substantially perpendicular to the surface of the container at the location at which they are mounted thereto.

On each support member 134, the second segment 154 forms an obtuse angle 58 with the first segment 146. The angle 58 in the embodiment depicted is between 90 degrees and 135 degrees. The placement of ends 138, brackets 149, etc. relative to the container 18 is substantially identical to the embodiment of FIG. 1.

Bracket 200 includes the plate 149, and a bent tube 208 that defines the first segment 146, the intersection 150, and about 7 inches of the second segment 154. The pole 204 is inserted into a hole formed in tube 208 to define the remainder of the second segment 154, including the end 142.

While the best modes for carrying out the invention have been described in detail, those familiar with the art to which this invention relates will recognize various alternative designs and embodiments for practicing the invention within the scope of the appended claims.

1. An apparatus comprising:
an animal feeding system having a container for storing animal feed and a dispenser operatively connected to the container and configured to dispense the animal feed from the container;
a plurality of support members;
wherein each of said support members has a respective first segment and a respective second segment;
wherein each of said first segments are substantially horizontal;
wherein each of said second segments are generally vertical; and
wherein the first segments are mounted with respect to the container.

2. The apparatus of claim 1, wherein the first segments are at least 5 inches long.

3. The apparatus of claim 2, wherein the first segments are at least 12 inches long.

4. The apparatus of claim 3, wherein the first segments are at least 24 inches long.

5. The apparatus of claim 1, wherein the container has a bottom end and a top end;
wherein the vertical distance between the bottom end and the top end defines the height of the container; and
wherein the first segments are connected to the container in the upper half of the height.

6. The apparatus of claim 5, wherein the first segments are connected to the container in the upper 25% of the height.

7. The apparatus of claim 6, wherein the first segments are connected to the container in the upper 10% of the height.

8. An apparatus comprising:
an animal feeding system having a substantially cylindrical container for storing animal feed and a dispenser operatively connected to the container and configured to dispense the animal feed from the container;
said container having an outer surface and a centerline;
a plurality of support members;
wherein each of said support members has a respective first segment and a respective second segment;
wherein each of said first segments are mounted with respect to the outer surface such that the first segments extend radially outward relative to the centerline; and
wherein each of said second segments is at an angle of between 90 and 135 degrees with its corresponding first segment.
